(19) United States
(12) Patent Application Publication
(10) Pub. No.: US 2014/0236733 A1
(43) Pub. Date: Aug. 21, 2014

(54) INTERACTIVE MULTILINGUAL ADVERTISEMENT SYSTEM, AND METHOD FOR DRIVING SAME

(71) Applicant: SOMMERCE LTD., Seoul (KR)

(72) Inventors: Okrae Cho, Yongin-si (KR); Eungsu Kim, Seoul (KR)

(73) Assignee: SOMMERCE LTD., Seoul (KR)

(21) Appl. No.: 14/350,023

(22) PCT Filed: Oct. 4, 2012
(86) PCT No.: PCT/KR2012/008010

§ 371 Date: Apr. 4, 2014

(30) Foreign Application Priority Data
Oct. 4, 2011 (KR) 10-2011-0100514

(51) Int. Cl. G06Q 30/02

(52) U.S. Cl. CPC G06Q 30/0269
USPC 705/14.66

(57) ABSTRACT

Provided is an interactive multilingual advertisement system and method for driving same using a social network service which does away with the modification of a social network service server or with the use of personal information on users and social network groups, determines a used language only from information selectively provided by a user terminal, and effectively provides related advertisements. The present invention relates to an interactive multilingual advertisement system and to a method for driving same using a social network service which determines a used language only from information selectively provided by a user terminal, provides related advertisements in a corresponding language, and provides advertisement information that a user can block or use to connect to an advertisement service.

### BACKGROUND

Present invention relates to an interactive multilingual advertisement system and to a method for driving same using a social network service, and in particular, to an interactive multilingual advertisement system and to a method for driving same, which does away with the modification of a social network service server or with the use of personal information on users and social network groups, determines a used language only from information selectively provided by a user terminal, and effectively provides related advertisements.

‘Social network service (will be denoted ‘SNS’ hereafter)’ to enable to establish personal network on web, and to share and exchange personal information connecting the node of a person or a group to other nodes.

In the beginning of SNS service it was mainly utilized for promote friendship or entertainment however, it is developed as a mean for business, sharing various information, and other productive usages. It is extended more to services among countries via personal mobile terminals.

FIG. 1 shows a scheme of SNS service system using personal mobile terminals. Within the system, each of personal mobile terminal is connected to acquaintances or people of same interest through SNS server to establish a network tying each node of a person or a group.

The information transferred through the SNS service network can be more reliable and can be propagated in a simple way, many of prior arts propose technologies to offer advertisement information in combination with the SNS services.

FIG. 2 shows a construction of Korean patent publication KR 10-2011-0058169 A, as a prior art. This art relates to a system and method of providing customized information of a post unit to show advertisement directly and effectively to visitors reading the corresponding text by providing advertisement information corresponding to meta information of the posting to a social network. A web server applies letter module received from a post advertisement server. If a letter is posted, the web server extracts meta information by analyzing the posted letter through the letter module. The web server requests advertisement information corresponding to the extracted meta information to the post advertisement server. If the posted letter is selected from a random terminal, the web server posts the advertisement information to the random terminal after receiving advertisement information related to the meta information from the post advertisement server. This art offering ads to posted articles of social network, still has problems not to protect privacy of social network, because control unit manages information on subscribers and sites to collect articles posted to web server through RSS. Furthermore the web server randomly offers ads to terminals regardless of connected subscribers and language of the articles.

FIG. 3 shows a brief of Korean patent publication KR 10-2011-0048065 A, as another prior art. This technology directs to an improved system and method for online advertising using user social information. An advertising demand engine may be provided for selecting advertisements using user social information and online behavior to serve to a user for display. A social network engine may be provided for constructing a plurality of networks of correlated users from social network information and online behavior. These networks may be updated with additional online behavior. An advertisement previously selected by a user or by other users belonging to a network constructed using social information and online behavior may be sent to users belonging to the same network in response to a request to serve an advertisement. In other embodiments, a ranked list of advertisements selected by users in multiple networks may be determined, and advertisements may then be sent to users from the ranked list of advertisements. This art also can not guarantee privacy of social network, to collect social information and online behavior of users by the social network engine, and the users are not allowed to block unwanted ads to be sent from the engine.

FIG. 4 shows a scheme of US 2006/0282328 A, as a prior art. This art discloses a method ad system of profiling a user for targeting advertisements. The method and system obtains and/or infers demographic information from end-users using on-line means. The invention next monitors end user activity and determines keywords therefrom. The system and method profiles an end user as a function of the determined end-user activity keywords and obtained/inferred end-user demographic information. Profiles of end-users are matched against targeted profiles of advertisements which are defined by the respective advertisers. This results in targeting advertisements to end-users based on end user profiles. Advertisers bid for advertisement placement with the system. In some embodiments, the system employs Vickrey auction type bidding. Using observed user behavior and the auction results, ads are prioritized for selection and viewing placement in a manner that provides the greatest potential value to the system. This art contains apprehension that the most of serviced ads can be unneeded by the end user and that some ads can be offered repeatedly, because the serviced ads are only based upon end user profiles.

FIG. 5 shows a diagram of US 2008/0189169 A, as a prior art. This art directs to a system and method for integrating analytics data of user profiles within a social network with targeted ad campaigns. The system includes an advertisement targeting system that obtains analytics data of user profiles and utilizes the data to filter through the user profiles to select desired user profiles for delivery of advertisements targeted to the interests and personality of the desired user profiles. Utilization of the analytics data includes generating a social rank of each user profile relevant to other user profiles in the social network. An advertising marketplace is implemented for use by ad marketers to purchase advertisement rights on a user profile webpage, to filter through user profiles in a social network for select user profiles with desired analytics data, and to generate advertisement campaigns targeted to the selected user profiles within a social network. This technology also collects user information to obtain analytic data and user profiles, and the users can not block the ads.

### SUMMARY OF THE INVENTION

Advantageously the present invention overcomes the deficiencies in the said prior arts. The invention provides an interactive multilingual advertisement system and to a method for driving same using a social network service, which does away with the modification of a social network service server or with the use of personal information on users and social network groups, determines ads using the words selectively provided by each of user terminal, and effectively provides related advertisements. The present invention also offers an interactive multilingual advertisement system and a method for driving same using a social network service which determines a used language selectively provided by a user terminal, and provides related advertisements in a corresponding language, and provides advertisement information that a user can selectively block or connect to an advertisement service.

The present invention offers an interactive multilingual advertisement system and to a method for driving same using a social network service as technical solution; configuring all of user terminals, social network group, ads server and ads sponsors as same social network service subscribers connected to SNS server; deciding user's language and servicing related ads only based on the information selectively supplied from the user terminals; enabling the users to block or to connect ads service.

The present invention offers an interactive multilingual advertisement system and to a method to protect SNS privacy to connect user terminals, social network group, ads server and ads sponsors as same social network service subscribers connected to SNS server; to service ads only based on the information selectively supplied from the user terminals; and to enable the users to block or to connect ads service.

### BRIEF DESCRIPTION OF DRAWINGS

FIG. 1 shows a scheme of SNS service system using personal mobile terminals

FIG. 2 shows a construction of a prior art of a system and method of providing customized information

FIG. 3 shows another prior art, an improved system and method for online advertising using user social information.

FIG. 4 shows a prior art, a method ad system of profiling a user for targeting advertisements.

FIG. 5 shows a prior art, a system and method for integrating analytics data of user profiles within a social network with targeted ad campaigns.

FIG. 6 shows conventional structures of ads providing social network service system.

FIG. 7 shows construction of interactive multilingual advertisement system of the present invention.

FIG. 8 shows a connection scheme of the present invention.

FIG. 9 shows process model for a sponsor to subscribe to the ads server.

FIG. 10 is a operational flow of the user terminal of the present invention.

FIG. 11 shows the detailed structure of ads server of the invention.

FIG. 12 shows the detailed structure of the user terminal of the invention.

FIG. 13 is a flow chart of the ads server operating method for a sponsor

FIG. 14 is a flow chart of the ads server operating method for a user terminal.

FIG. 15 shows a flow chart of operating method for the user terminal

FIG. 16 is an example of the user terminal screen of the present invention.

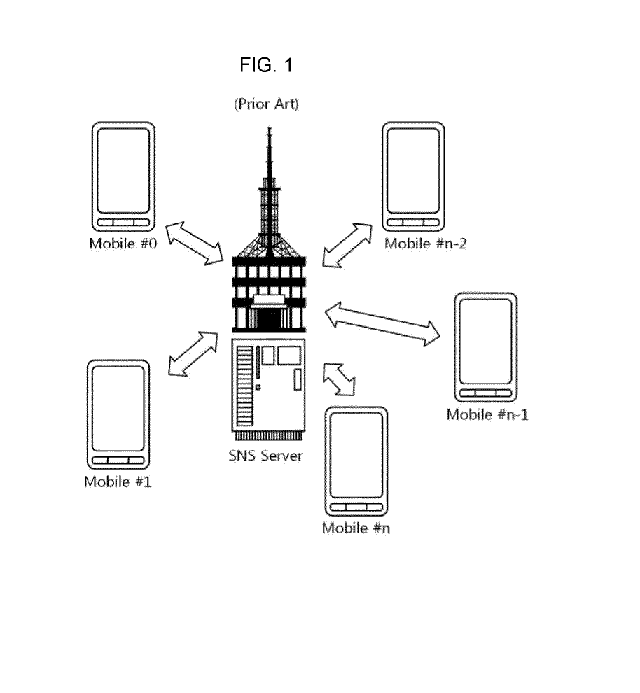

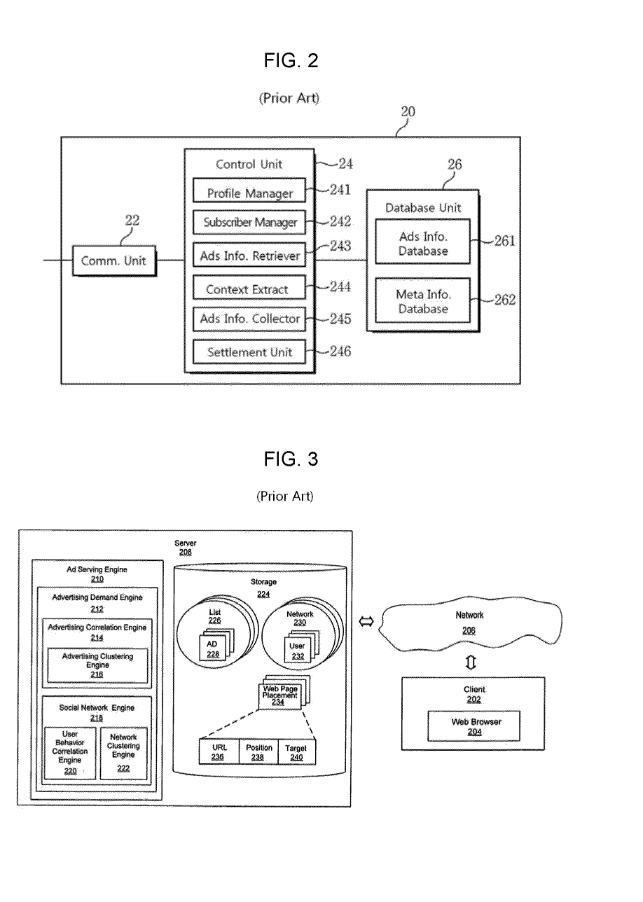

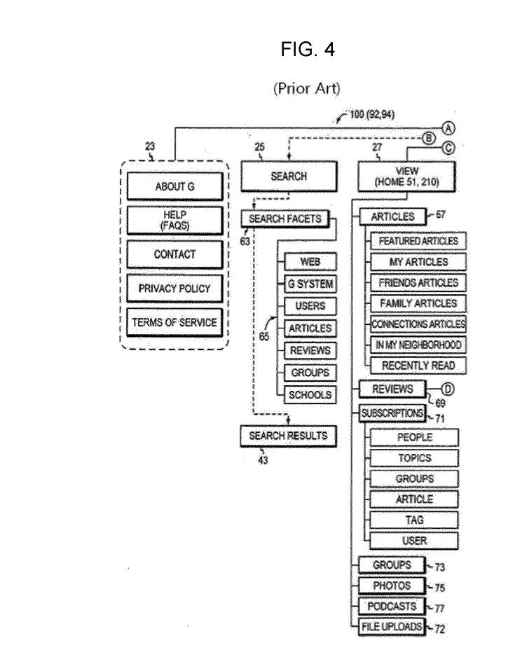

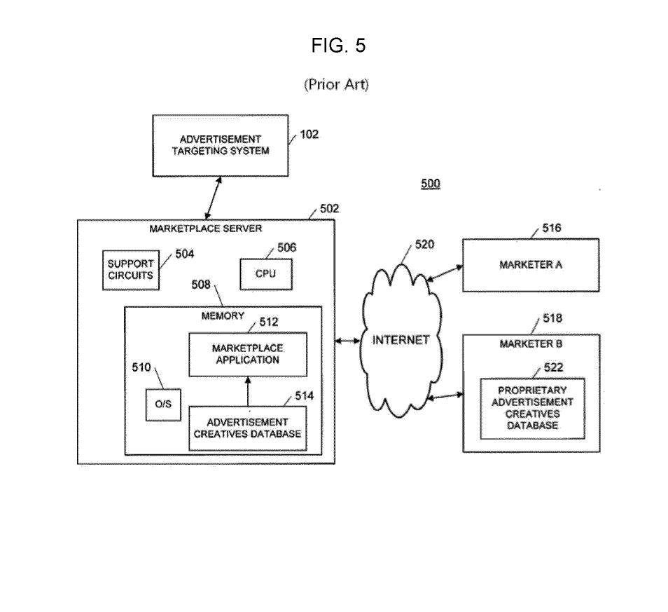

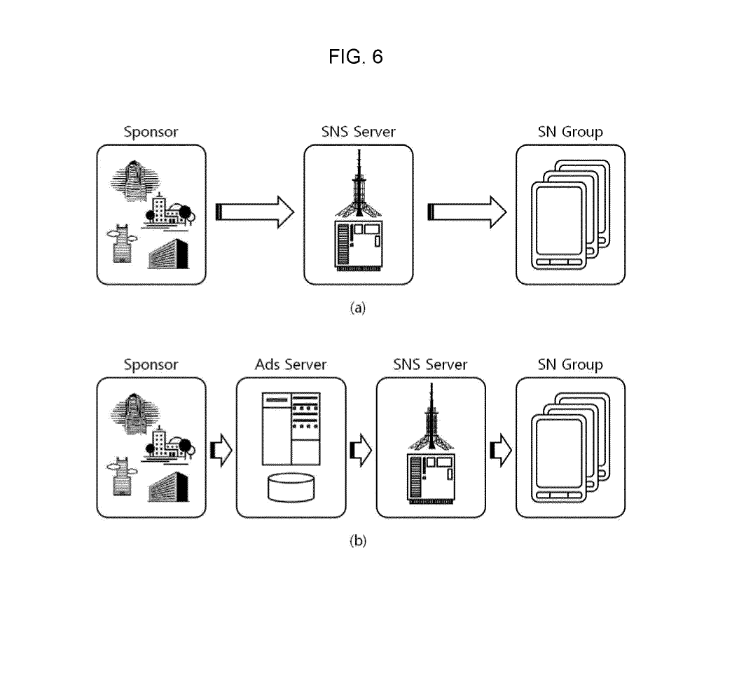

### DETAILED DESCRIPTION OF THE INVENTION

As the best mode of system, the invention offers an interactive multilingual advertisement system to connect user terminals, social network group, ads server and ads sponsors as same social network service subscribers connected to SNS server.

As the method for operating the interactive multilingual advertisement system with user terminals, social network group, ads server and ads sponsors connected to SNS server comprising the steps; each user terminal executes application program transmitted from the ads server, then each user terminal is simultaneously connected to social network group and to ads server, the user terminal extracts and sends the words from the exchanged SNS messages or posted articles, ads server retrieves meta data using the words received from the user terminal, and the ads server transmits ads data linked meta data with URL information read out from the ads database, the user terminal displays received ads data and URL information to connect to the advertisement sponsor's URL.

The principles of the present invention will be shown hereinafter. Hence, although not shown or not clearly described, it should be understood by one of ordinary skill in the art that the principles of the present invention can be embodied and various devices included within the concept and scope of the present invention can be invented. Also, it should be understood that all terms and embodiments enumerated in the specification are only intended to explain the concept of the present invention and the present invention is not limited to the embodiments and states. Also, it should be understood that all detailed description of the exemplary embodiments is intended to include not only the principles, the aspects, and the exemplary embodiments of the present invention but also structural and functional equivalents thereof.

Also, it should be understood that the equivalents include not only currently publicized equivalents but also equivalents to be developed in the future, that is, all devices to be developed to perform the same function irrespective of their structures. Functions of various devices that are illustrated in drawings including a function block denoted as a processor or as a similar concept to the processor, can be provided not only with specific hardware but also general hardware in which related software can be executed. When these functions are provided by the processor, the functions may be provided by a singular specific processor, a singular sharable processor, or plural processors in which sharing between the plural processors is possible. Also, usage of terms such as a processor, a control, or the like should not be construed as being limited to hardware capable of executing software but should be construed as indirectly including digital signal processor (DSP) hardware, read-only memory (ROM), random-access memory (RAM), and non-volatile memory used for storing software. Other well-known conventional hardware devices may be included.

Hereinafter, the present invention will be described in detail by explaining exemplary embodiments of the invention with reference to the attached drawings. Detailed explanation will not be given when it is determined that detailed explanation about well-known function and configuration of the present invention may dilute the point of the present invention. The present invention will now be described more fully with reference to the accompanying drawings, in which exemplary embodiments of the invention are shown.

FIG. 6 shows conventional structures of ads providing social network service system.

Figure (a) presents a structure of ads system wherein, each ads sponsor—includes plural servers of each ads sponsor, will be denoted as ‘ads sponsor’ hereafter—is connected to a SNS service server to provide ads. In this case, only the ads from the sponsors are unilaterally supplied regardless of needs from the SNS group. In addition, it can degrade the SNS quality to interrupt SNS with unnecessary information.

Figure (b) shows another structure of ads system wherein, an ads server is equipped to the SNS server to gather ads from sponsors and to provide toward SN group. In this structure, as introduced in the prior arts, the SNS server collects and analyzes information on the target SNS users and SN groups. Thus the cost of system increases to prepare ads server together with SNS service, and privacy problem arose to utilize personal information.

In the conventional ads service technology with SNS shown in the FIG. 6 contains limitations, that users can not block or connect to an advertisement service selectively, and not to offer multilingual ads service, because of providing unilateral ads from the sponsors.

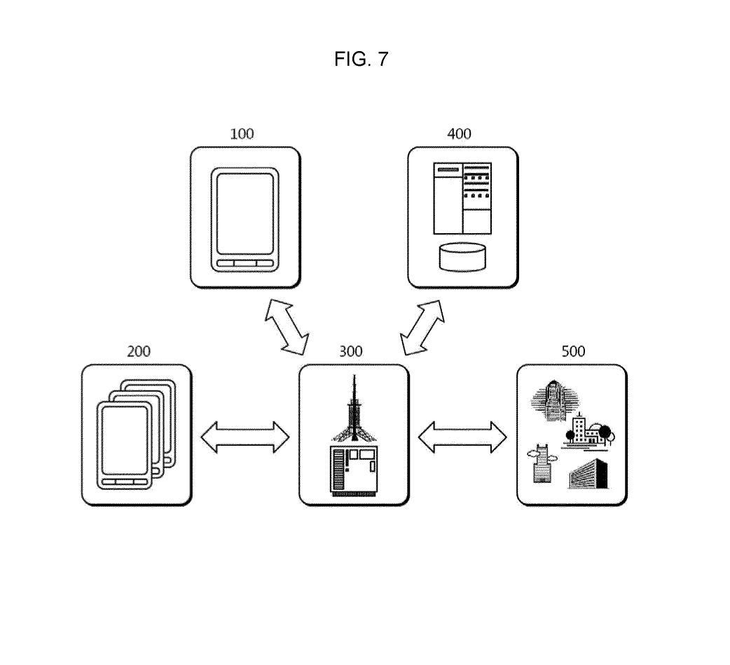

FIG. 7 shows construction of interactive multilingual advertisement system of the present invention. In the present invention, user terminal (100), SN groups (200), ads server (400) and sponsor (500) are connected to SNS server (300) under SNS service. Therefore at the SNS server (300), all of user terminal (100), SN groups (200), ads server (400) and sponsor (500) are managed as SNS subscribers. The SNS server (300) only may relay information transferred between subscribers, not to process information on the user terminal (100) or SN groups (200), and possibly not to store or analyze messages and posted articles. Thus hereafter to explain specific aspects of the invention more clearly, transmission of information through the SNS server (300) will be omitted in the mode of invention, because it only relays information from/to user terminal (100), SN groups (200), ads server (400) and sponsor (500). Therefore it is explained that the information is exchanged between two of user terminal (100), SN groups (200), ads server (400) and sponsor (500) in the description however, all the exchange should be understood to be established via SNS server (300).

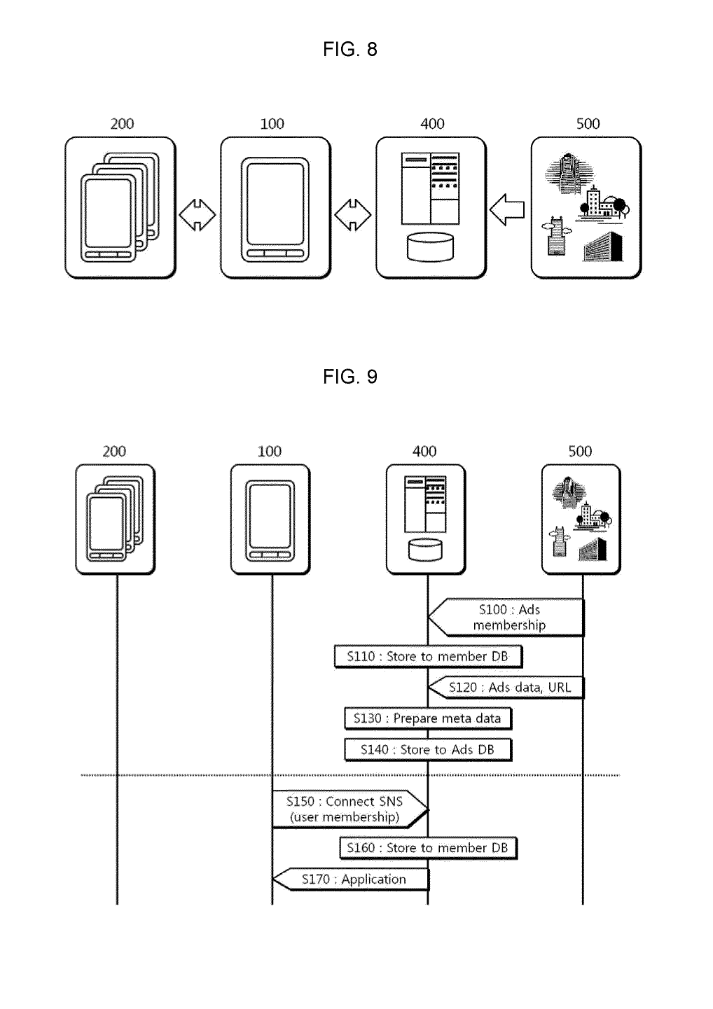

FIG. 8 shows a connection scheme of the present invention. The user terminal (100) can be connected to SN groups (200), and the ads server (400) is furnished with ads information from the sponsor (500). The user terminal (100) is provided with ads from ads server (400), and can be connected to the ads server (400) selectively by user. For this configuration, the sponsor (500) and preferably the user terminal (100) must be registered to the ads server (400). The user terminal (100) also possibly can be serviced with ads without said registration, and details will be explained later.

FIG. 9 shows process model for a sponsor (500) to subscribe to the ads server (400). The followings are the detailed steps of the process model.

First, a sponsor (500) connects to the ads server (400) and offers subscriber information to register as a member; (S100). Then the ads server (400) stores the subscriber's information into member DB; (S110). The subscriber information from the sponsor (500) may contain name of company and representative, business license number, phone numbers.

Next, the sponsor (500) as a subscribed member sends ads data and URL information toward ads server (400) to store; (S120). The ads data comprise text and graphic data including name of company, slogans, title of product and services, and keywords of ads. The URL information is to connect the user terminal (100) to homepage or shopping page of the sponsor (500). The ads data is provided to the ads server (400) in multilingual by the sponsor (500).

Then the ads server (400) prepares and stores meta data from the provided ads data for each language; (S130), and stores ads data and URL of the sponsor (500) into ads database; (S140), to finish subscription process of the sponsor (500). The meta data stored by the ads server (400) is text data including name of company, slogans, title of product and services, and keywords of ads, provided by the sponsor (500).

For example, if name of company is ‘XX book store’, and meta data stored in the ads server (400) can be the words ‘reading’, ‘book’, paperback’, ‘magazine’ as the sponsor (500) inputs for the words for slogans, title of product and services, and keywords. For another example. when name of company is ‘YY used car sales’, the meta data can be ‘used car’, ‘imported car’, ‘truck’, and model names of cars.

The meta data also can be a plurality of data comprising link header or tag to be accessed by the ads server (400) linking to ads data files and URL information stored in the ads database. For example, when a plurality of the sponsors (500) of ‘book stores’ input ‘book’ as keywords, the ads server (400) prepares ‘book+name of company’ as meta data and each of ads data file name from the sponsors (500) is arranged to the ‘name of company’ and stored into the ads database. If the ads server (400) refers meta data with the keyword ‘book’, a multiple ‘book+name of company’ data will be retrieved to access each ads data file with the file names of ‘name of company’.

Back to FIG. 9, after the sponsor (500) to subscribe user terminal (100) can subscribe to the ads server (400).

The user terminal (100) is connected to the ads server (400) through SNS, and subscribes as a member; (S150). The information provided from the user terminal (100) to the ads server (400) for subscription include SNS ID of the user, mobile number of the user terminal, which are stored into member database by the ads server (400); (S160). The member database is subdivided into sponsor (500) database and user terminal (100) database, and managed independently. After receiving the information from the user terminal (100), the ads server (400) transmits application program to the user terminal (100); (S170) to finish subscription process.

Since the application program can be offered online, the user terminal( 100) also can be serviced without subscribing to the ads server (400) of the invention by downloading the application from other sites or any other available services.

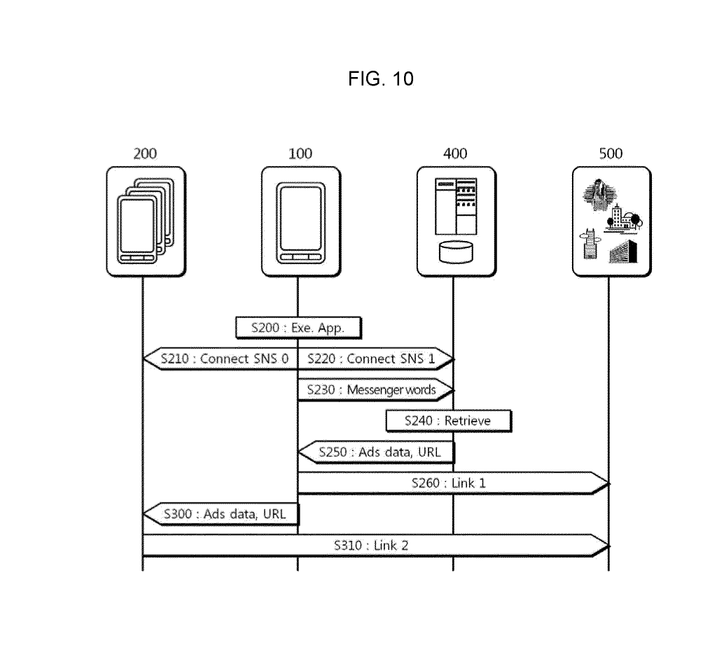

FIG. 10 is a operational flow of the user terminal (100) by the interactive multilingual advertisement system of the present invention. The detailed steps are as follows.

First, at the user terminal (100) side the application program downloaded from the ads server (400) is executed; (S200). The application program comprises the process adding the ads server (400) to the SNS to which the user terminal (100) connects. Hence the advertising service can be activated at the user terminal (100) by connecting to the SNS through the downloaded application, and can be deactivated by connecting to SNS bypassing the application. This feature of the invention enables the user terminal (100) selectively to activate or to block the advertising services combined to SNS.

After executing the application, the user terminal (100) is connected to SN group (200) together with the ads server (400); (S210),

Then the user starts to exchange text information of SNS messenger or posted articles, the user terminal (100) extracts words of the text information and transmits to the ads server (400); (S230). The ads server (400) retrieves meta data using the received words from the user terminal (100); (S240), and read out the ads data and URL information linked to the meta data from the ads database, and transmits back to the user terminal (100); (S250). The user terminal (100) displays the received ads data and URL information, also can be connected to the URL of the sponsor (500) referring to the displayed URL or touch screen means; (S260). The displayed ads data and URL information can be sent to SN group (200) by using ‘drag & move’ function; (S300). The each terminal of the SN group (200) also can be connected to the URL of the sponsor (500) referring to the displayed URL; (S310).

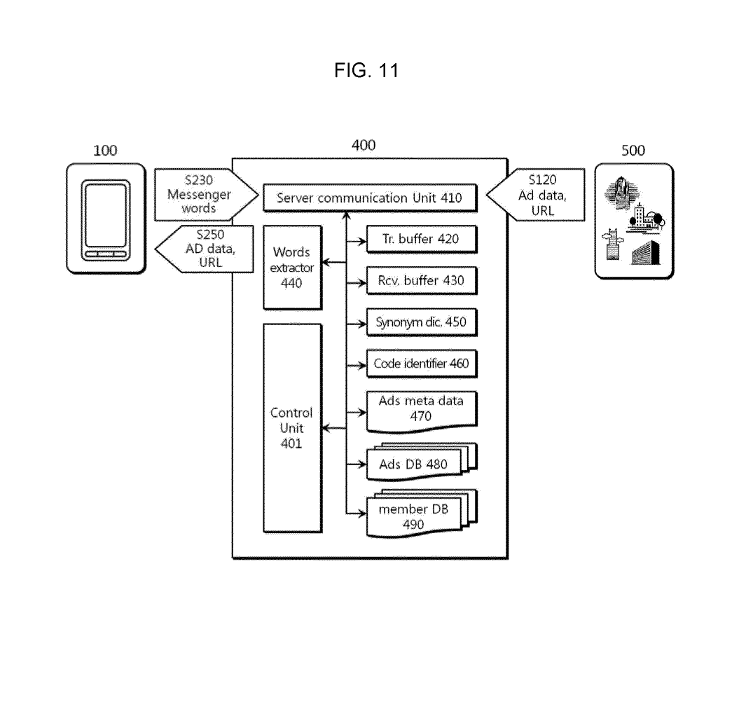

FIG. 11 shows the detailed structure of ads server (400) of the invention. The shown structure supports function explained in the FIG. 9 and the FIG. 10, and followings are functions and interactions of each elements.

Control Unit (401)

The control unit (401) executes control over the elements inside the ads server (400).

Server Communication Unit (410)

The server communication unit (410) is communication mean connected to external channels to SNS with internet packet communication mean.

Transmit Buffer (420)

The transmit buffer (420) stores data provided from the control unit (401), and the stored data is transmitted through the server communication unit (410) by the control of the control unit (401).

Receive Buffer (430)

The receive buffer (430) is a data buffer stores data received from the user terminal (100) and the sponsor (500), and provides to the control unit (401).

Words Extractor (440) The words extractor (440) extracts words of the data received from the user terminal (100) through the server communication unit (410), which extracts words referring ‘spaces’ or symbols.

Synonym Dictionary (450)

The synonym dictionary (450) is for the control unit (401) to retrieve synonyms and thesaurus of words from the words extractor (440). The control unit (401) can search out different words with same meaning of the words.

Code Identifier (460)

The code identifier (460) identifies character code of the words received through the server communication unit (410), and provides indentified code to the control unit (401). Especially, by the code identifier (460) the control unit (401) can distinguish language of SNS users by the code of words from the user terminal (100).

For example of the said character code identification; since the SNS words received from the user terminal (100) are in HTTP (HyperText Transfer Protocol) or HTML (hypertext markup language), the code identifier (460) can distinguish language by code referring to ‘charset’ parameter of ‘Content-Type Header’ of HTTP, ‘charset’ parameter set by ‘META declaration’ and ‘http-equiv’ attribute of HTML data, or other ‘charset’ parameters included in HTML files. The code identifier (460) firstly refers to ‘charset’ parameters for HTML format character code. If there is no ‘charset’ parameters or ‘Content-Type Header’, the code identifier (460) refers ‘META declaration’ inside HTML files and can distinguish language of SNS users by the code of words from the user terminal (100).

Ads Meta Data (470)

As mentioned in the FIG. 9, ads meta data (470) is text data stored by the ads server (400), including name of company, slogans, title of product and services, and keywords of ads, provided by the sponsor (500). The meta data stored by the ads server (400) is text data including name of company, slogans, title of product and services, and keywords of ads, provided by the sponsor (500). The text data retrieved from the synonym dictionary (450) by the control unit (401) also can be stored for each language as meta data.

Ads Database (480)

The ads database (480) stores multilingual ads data and URL information provided by the sponsor (500).

Member Database (490)

The member database (490) stores information on the subscribed sponsors (500) and user terminals (100). The member database is subdivided into sponsor (500) database and user terminal (100) database, and managed independently.

Applying the structure of the ads server (400), the sponsor (500) subscription process explained in the FIG. 9 can be described in details as follows.

First, the sponsor (500) subscribes to the ads server (400) as a member, and inputs ads data and URL information; the ads data and URL information is stored in the receive buffer (430) via the control unit (401) of the ads server (400).

Then the control unit (401) provide the code identifier (460) with the ads data and URL information from the receive buffer (430), and identify character code and language.

Next, the control unit (401) provides the words extractor (440) with the ads data, and extracts words referring ‘spaces’ or symbols.

And the control unit (401) provides synonym dictionary (450) with the extracted words, and synonyms and thesaurus of words from the words extractor (440) are retrieved.

Then, the control unit (401) stores words extracted from the ads data and synonyms and thesaurus of words, as the ads meta data (470) for each language.

Finally, the control unit (401) stores ads data file and URL information into the ads database (480) linking with ads meta data (470), to be accessed by the control unit (401).

Applying the structure of the ads server (400), the user terminal (100) operation process explained in the FIG. 10 can be described in details as follows.

The user terminal (100) extracts words of the text information of SNS messenger and transmits to the ads server (400), the information from the user terminal (100) is stored in the receive buffer (430) via the control unit (401) of the ads server (400).

Then, the control unit (401) provides the code identifier (460) with the ads data and URL information from the receive buffer (430), and identify character code and language.

Next, the control unit (401) provides the words extractor (440) with the receive buffer (430) data, and extracts words referring ‘spaces’ or symbols.

Then, the control unit (401) provides synonym dictionary (450) with the extracted words, and synonyms and thesaurus of words from the words extractor (440) are retrieved.

Next, the control unit (401) retrieves the ads meta data (470) for each language using the words extracted from the words extractor (440) and retrieved synonyms and thesaurus.

After searching out matched data from the ads meta data (470) for each language, the control unit (401) reads out ads data file and URL information linked to the matched ads meta data, and stores into the transmit buffer (420).

Finally the control unit (401) transmits data of the transmit buffer (420) to the user terminal (100) through the server communication unit (410).

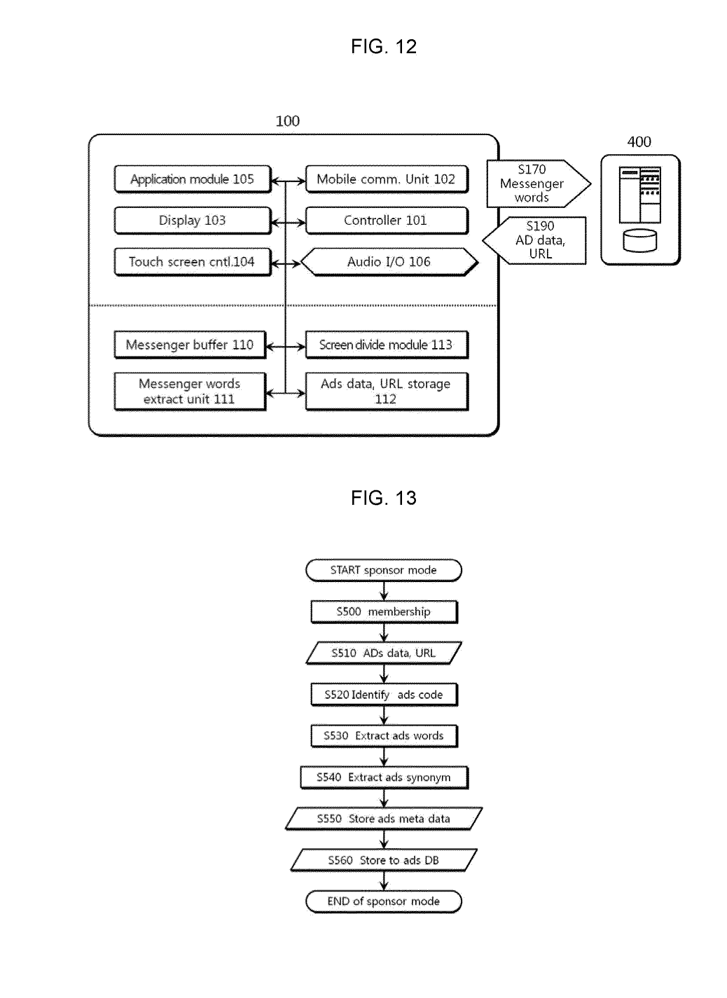

FIG. 12 shows the detailed structure of the user terminal (100) of the invention. The followings are functions and interactions of each elements.

The user terminal (100) of the invention comprises; controller (101), mobile communication unit (102), display (103), touch screen control (104), application module (105), and audio I/O (106), as conventional elements drawn in the upper side of dotted line in the figure.

The mobile communication unit (102) transmits and receives data from the user terminal (100) controlled by the controller (101). The display (103) displays information and data from the controller (101), and the touch screen control (104) detects signals from the touch screen sensor and provides detected result to the controller (101). The application module (105) stores and executes applications through the controller (101), usually with a plurality of functions to be selected by the user. The audio I/O (106) converts microphone input to transmit, and received data to audio signals.

The user terminal (100) of the invention more comprises; messenger buffer (110), messenger words extract unit (111), Ads data and URL storage (112), and screen divide module (113), as specific elements of the invention.

Messenger Buffer (110)

After the application of the invention is executed at the user terminal (100), and connected to SNS to exchange text information with SN group (200), the controller (101) saves each of exchanged text information into the messenger buffer (110) for further process.

Messenger Words Extract Unit (111)

The messenger words extract unit (111) extracts words from the text information stored in the messenger buffer (110). The messenger words extract unit (111) text information is separated into words referred by the ‘space’ between, and separated words are relocated in the messenger buffer (110) and scrambled.

Ads Data and URL Storage (112)

The ads data and URL storage (112) stores ads files and URL information received from the ads server (400). The stored ads files and URL information is read out by the controller (101) and displayed.

Screen Divide Module (113)

The screen divide module (113) offers the function dividing the display (103) into SNS display area and ads display area. The screen divide function is driven by the controller (101).

Applying the structure of the user terminal (100) of the invention, the user terminal (100) operation process explained in the FIG. 10 can be described in details as follows.

First, the application of the invention received from the ads server (400) is executed at the user terminal (100), the controller (101) activates the screen divide module (113) and the display (103) is divided into SNS display area and ads display area.

Next, the controller (101) connects the user terminal (100) to user selected SN group (200) and ads server (400) through the mobile communication unit (102).

Then, the user terminal (100) start to exchange text information with SN group (200), and the controller (101) saves each of exchanged text information into the messenger buffer (110).

The controller (101) provides messenger words extract unit (111) with the text information stored in the messenger buffer (110), and text information is separated into words referred by the ‘space’ between, and separated words are relocated in the messenger buffer (110) and scrambled.

Finally, the controller (101) transmits the words from the messenger buffer (110) to the ads server (400) through the mobile communication unit (102), and the controller (101) stores ads data file and URL information received from the ads server (400) into the ads data and URL storage (112). The ads data file and URL information stored in the ads data and URL storage (112) is read out by the controller (101), and displayed as ads.

FIG. 13 is a flow chart of the ads server (400) operating method for a sponsor (500) to subscribe to the ads server (400), as interactive multilingual advertisement system operating method of the invention.

The followings are the detailed steps of the method.

First, the step a sponsor (500) connects to the ads server (400) and subscribes as a member; (S500).

Next step, the sponsor (500) inputs ads data and URL information to ads server (400); (S510).

Then the control unit (401) provide the code identifier (460) with the ads data and URL information from the receive buffer (430), and identify character code and language; (S520).

Next, the control unit (401) provides the words extractor (440) with the ads data, and extracts words referring ‘spaces’ or symbols; (S530).

And the control unit (401) provides synonym dictionary (450) with the extracted words, and synonyms and thesaurus of words from the words extractor (440) are retrieved; (S540).

Then, the control unit (401) stores words extracted from the ads data and synonyms and thesaurus of words, as the ads meta data (470) for each language; (S550).

Finally, the control unit (401) stores ads data file and URL information into the ads database (480) linking with ads meta data (470), to be accessed by the control unit (401); (S560).

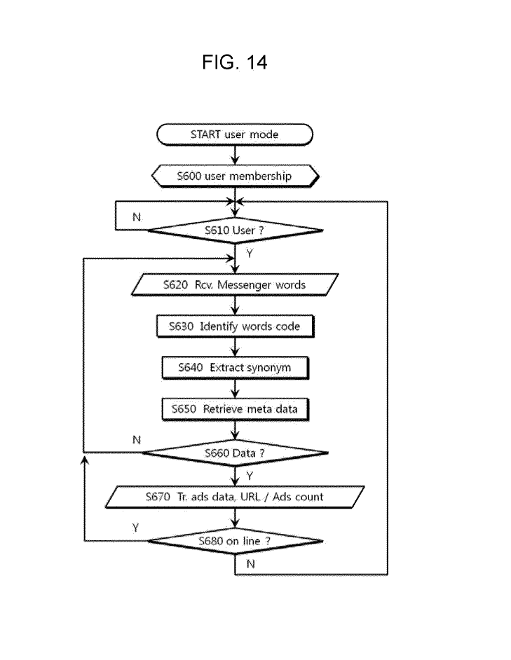

FIG. 14 is a flow chart of the ads server (400) operating method for the user terminal (100), as interactive multilingual advertisement system operating method of the invention.

The followings are the detailed steps of the method.

First, the application program provided from the ads server (400) is executed at the user terminal (100) subscribed as a member to the ads server (400); (S600).

The control unit (401) of the ads server (400) checks if SNS messenger text information from the user terminal (100) is received; (S610), and stand-by for the SNS messenger text information.

At the said step; (S610), if SN messenger text information from the user terminal (100) is received via server communication unit (410), then the control unit (401) stores received SN messenger text information into the receive buffer (430); (S620).

Then the control unit (401) reads out stored text information from the receive buffer (430), and provides the code identifier (460) with the reads out text information from the receive buffer (430), and identify character code and language. and the control unit (401) provides the words extractor (440) with the receive buffer (430) data with the text information, and extracts words referring ‘spaces’ or symbols; (S630).

Next, the control unit (401) provides synonym dictionary (450) with the extracted words, to search out synonyms and thesaurus; (S640).

Then the control unit (401) retrieves the ads meta data (470) for each language using the words extracted from the words extractor (440) and retrieved synonyms and thesaurus; (S650).

At the said step; (S650), if matched data is not searched out from the ads meta data (470), the control unit (401) re-executes the said step (S620).

At the said step; (S650), if matched meta data is searched out from the ads meta data (470), the control unit (401) reads out ads data file and URL information linked to the matched meta data and stores transmit buffer (420), and transmits transmit buffer (420) data to the user terminal (100) via server communication unit (410); (S670).

At the said step (S670), the control unit (401) may additively count exposure frequency of the ads data files and URL for the concerned sponsor (500), and count the frequency of transmission of the ads data files and URL for the concerned user terminal (100), to record into subscriber database respectively.

Followed by the previous step, the control unit (401) checks whether the user terminal (100) sustains connection; (S680), and for connected status the control unit (401) jumps to the step (S620), and for disconnected status jumps to the step (S610), and stand-by for the receiving text information from the user terminal (100).

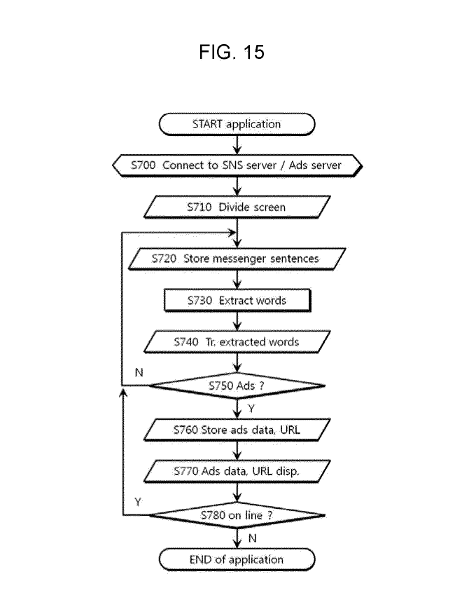

FIG. 15 shows a flow chart of operating method for the user terminal (100), as interactive multilingual advertisement system operating method of the invention.

The followings are the detailed steps of the method

First, the application of the invention received from the ads server (400) is executed at the user terminal (100); (S700).

Then the controller (101) activates the screen divide module (113) and the display (103) is divided into SNS display area and ads display area; (S710).

Next, the user terminal (100) start to exchange text information with SN group (200), and the controller (101) saves each of exchanged text information into the messenger buffer (110); (S720).

The controller (101) provides messenger words extract unit (111) with the text information stored in the messenger buffer (110), and text information is separated into words referred by the ‘space’ between, and separated words are relocated in the messenger buffer (110) and scrambled; (S730).

Followed by the step (S730), the controller (101) transmits the words from the messenger buffer (110) to the ads server (400) via mobile communication unit (102); (S740).

Next, the controller (101) waits and checks whether the ads data files and URLs received from the ads server (400); (S750).

At the previous step (S750), if there is no ads data files and URLs received from the ads server (400), the controller (101) jumps to the step (S720) to repeat process in sequence.

At the previous step (S750), if there are ads data files and URLs received from the ads server (400), the controller (101) stores received ads data files and URLs into the ads data and URL storage (112); (S760).

Next to the step (S760), the controller (101) reads out information from the ads data and URL storage (112) to be displayed on the display (103) as serviced advertisement; (S770).

And the controller (101) checks whether the user terminal (100) sustains connection to the SN group (200); (S780), and for connected status the the controller (101) jumps to the step (S720),

and for disconnected status the controller (101) ends operation of the user terminal (100).

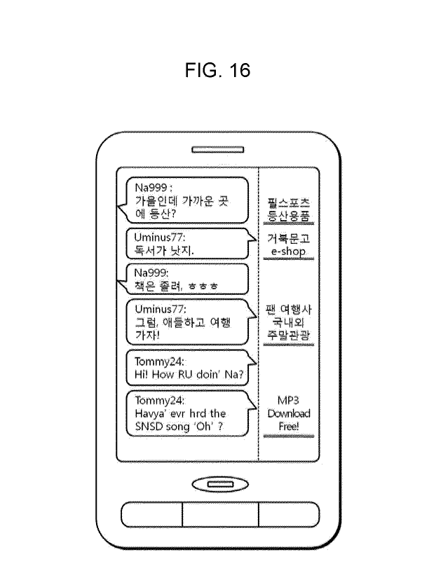

FIG. 16 is an example of the user terminal (100) screen of the present invention. As mentioned above, the screen of the user terminal (100) is divided into SNS display area and ads display area by the divide module (113). When the user starts to exchange text information of SNS messenger or posted articles with SNS group (200), corresponding ads information provided from the ads server (400) is displayed on the ads display area. Since the ads information is provided with URL information of the sponsor (500), can be displayed in hyper-text or hyper-link format, which enables transferred to the SN group (200) as a message using ‘drag-and-move’ touch screen function of the user terminal (100).

The present invention can be used in the field of advertisement industries utilizing social network service to establish personal network, and to share and exchange personal information connecting the node of a person or a group to other nodes.

What is claimed is:

1. An interactive multilingual advertisement system comprising;
user terminal (100), SN groups (200), ads server (400) and sponsor (500) are connected to SNS server (300) under SNS service,
and all of user terminal (100), SN groups (200), ads server (400) and sponsor (500) are managed as SNS subscribers.

2. A method for operating an interactive multilingual advertisement system for a sponsor to subscribe to the ads server comprising;
a sponsor (500) connects to the ads server (400) and offers subscriber information to register as a member; (S100),
then the ads server (400) stores the subscriber's information containing name of company and representative, business license number, phone numbers into member DB; (S110),
next, the sponsor (500) as a subscribed member sends ads data and URL information toward ads server (400) to store; (S120),
then the ads server (400) prepares and stores meta data from the provided ads data for each language; (S130), and stores ads data and URL of the sponsor (500) into ads database; (S140), to finish subscription process of the sponsor (500).

3. The meta data of claim 1 comprising;
text data to include name of company, slogans, title of product and services, and keywords of ads, provided by the sponsor (500).

4. A method for operating an interactive multilingual advertisement system for a user terminal to subscribe to the ads server comprising;
the user terminal (100) is connected to the ads server (400) through SNS, and subscribes as a member; (S150), and the information provided from the user terminal (100) to the ads server (400) for subscription include SNS ID of the user, mobile number of the user terminal, which are stored into member database by the ads server (400); (S160),
then after receiving the information from the user terminal (100), the ads server (400) transmits application program to the user terminal (100); (S170) to finish subscription process.

5. The member database of one of the claim 2 or claim 4 comprising;
a database subdivided into sponsor (500) database and user terminal (100) database, and managed independently.

6. The method for operating an interactive multilingual advertisement system for a user terminal to subscribe to the ads server of claim 4 more comprising;
to be operated be serviced by the invention by downloading the application without subscribing to the ads server (400).

7. A method for operating an interactive multilingual advertisement system for a user terminal to operate comprising;
first, at the user terminal (100) side the application program downloaded from the ads server (400) is executed; (S200),
after executing the application, the user terminal (100) is connected to SN group (200) together with the ads server (400); (S210),
then the user starts to exchange text information of SNS messenger or posted articles, the user terminal (100) extracts words of the text information and transmits to the ads server (400); (S230),
the ads server (400) retrieves meta data using the received words from the user terminal (100); (S240),
and read out the ads data and URL information linked to the meta data from the ads database, and transmits back to the user terminal (100); (S250),
the user terminal (100) displays the received ads data and URL information, and connected to the URL of the sponsor (500) referring to the displayed URL or touch screen means; (S260).

8. The step the ads server (400) retrieves meta data using the received words from the user terminal (100); (S240) of claim 7 more comprising the steps of;
displayed ads data and URL information is sent to SN group (200) by using ‘drag & move’ function; (S300) and the each terminal of the SN group (200) is connected to the URL of the sponsor (500) referring to the displayed URL; (S310).

9. An interactive multilingual advertisement system comprising;
a control unit (401) to execute control over the elements inside the ads server (400),
a server communication unit (410) connected to external channels to SNS with internet packet communication mean,
a transmit buffer (420) to store data provided from the control unit (401),
a receive buffer (430) to store data received from the user terminal (100) and the sponsor (500), and to provide stored data to the control unit (401),
a words extractor (440) to extract words of the data received from the user terminal (100) through the server communication unit (410), which extracts words referring ‘spaces’ or symbols,
a synonym dictionary (450) to retrieve synonyms and thesaurus of words from the words extractor (440),
a code identifier (460) to identify character code of the words received through the server communication unit (410), and to provide indentified code to the control unit (401),
ads meta data (470) mean to store text data including name of company, slogans, title of product and services, and keywords of ads, provided by the sponsor (500),
an ads database (480) to store multilingual ads data and URL information provided by the sponsor (500),
a member database (490) to store information on the subscribed sponsors (500) and user terminals (100), subdivided into sponsor (500) database and user terminal (100) database, and managed independently.

10. The code identifier (460) of claim 9 more comprising;
for SNS words received from the user terminal (100) in HTTP (HyperText Transfer Protocol) or HTML (hypertext markup language), the code identifier (460) distinguish language by code referring to ‘charset’ parameter of ‘Content-Type Header’ of HTTP, ‘charset’ parameter set by ‘META declaration’ and ‘http-equiv’ attribute of HTML data, or other ‘charset’ parameters included in HTML files.

11. The ads server (400) of claim 9 comprising;
the sponsor (500) subscribes to the ads server (400) as a member, and inputs ads data and URL information; the ads data and URL information is stored in the receive buffer (430) via the control unit (401) of the ads server (400),
then the control unit (401) provide the code identifier (460) with the ads data and URL information from the receive buffer (430), and identify character code and language,
next, the control unit (401) provides the words extractor (440) with the ads data, and extracts words referring ‘spaces’ or symbols,
and the control unit (401) provides synonym dictionary (450) with the extracted words, and synonyms and thesaurus of words from the words extractor (440) are retrieved,
then, the control unit (401) stores words extracted from the ads data and synonyms and thesaurus of words, as the ads meta data (470) for each language,
and, the control unit (401) stores ads data file and URL information into the ads database (480) linking with ads meta data (470), to be accessed by the control unit (401).

12. The ads server (400) of claim 9 comprising;
the user terminal (100) extracts words of the text information of SNS messenger and transmits to the ads server (400), the information from the user terminal (100) is stored in the receive buffer (430) via the control unit (401) of the ads server (400),
then, the control unit (401) provides the code identifier (460) with the ads data and URL information from the receive buffer (430), and identify character code and language,
next, the control unit (401) provides the words extractor (440) with the receive buffer (430) data, and extracts words referring ‘spaces’ or symbols,
then, the control unit (401) provides synonym dictionary (450) with the extracted words, and synonyms and thesaurus of words from the words extractor (440) are retrieved,
next, the control unit (401) retrieves the ads meta data (470) for each language using the words extracted from the words extractor (440) and retrieved synonyms and thesaurus,
after searching out matched data from the ads meta data (470) for each language, the control unit (401) reads out ads data file and URL information linked to the matched ads meta data, and stores into the transmit buffer (420),
and the control unit (401) transmits data of the transmit buffer (420) to the user terminal (100) through the server communication unit (410).

13. An interactive multilingual advertisement system comprising;
a user terminal (100) wherein,
a messenger buffer (110) to which controller (101) saves each of exchanged text information,
a messenger words extract unit (111) to extract words from the text information stored in the messenger buffer (110),
a ads data and URL storage (112) to store ads files and URL information received from the ads server (400),
a screen divide module (113) to offer the function dividing the display (103) into SNS display area and ads display area.

14. The messenger words extract unit (111) of claim 13 comprises;
to extract words from the text information stored in the messenger buffer (110), and to separate text information into words referring the ‘space’ between, and to relocate and scramble the separated words in the messenger buffer (110).

15. The user terminal (100) of claim 13 comprising;
the application of the invention received from the ads server (400) is executed at the user terminal (100), the controller (101) activates the screen divide module (113) and the display (103) is divided into SNS display area and ads display area.
next, the controller (101) connects the user terminal (100) to user selected SN group (200) and ads server (400) through the mobile communication unit (102),
then, the user terminal (100) start to exchange text information with SN group (200), and the controller (101) saves each of exchanged text information into the messenger buffer (110),
the controller (101) provides messenger words extract unit (111) with the text information stored in the messenger buffer (110), and text information is separated into words referred by the ‘space’ between, and separated words are relocated in the messenger buffer (110) and scrambled,
and, the controller (101) transmits the words from the messenger buffer (110) to the ads server (400) through the mobile communication unit (102), and the controller (101) stores ads data file and URL information received from the ads server (400) into the ads data and URL storage (112). The ads data file and URL information stored in the ads data and URL storage (112) is read out by the controller (101), and displayed as ads.

16. A method for operating an interactive multilingual advertisement system comprising;
first, the step a sponsor (500) connects to the ads server (400) and subscribes as a member; (S500)
next step, the sponsor (500) inputs ads data and URL information to ads server (400); (S510)
then the control unit (401) provide the code identifier (460) with the ads data and URL information from the receive buffer (430), and identify character code and language; (S520)
next, the control unit (401) provides the words extractor (440) with the ads data, and extracts words referring ‘spaces’ or symbols; (S530).
and the control unit (401) provides synonym dictionary (450) with the extracted words, and synonyms and thesaurus of words from the words extractor (440) are retrieved; (S540)
then, the control unit (401) stores words extracted from the ads data and synonyms and thesaurus of words, as the ads meta data (470) for each language; (S550)
finally, the control unit (401) stores ads data file and URL information into the ads database (480) linking with ads meta data (470), to be accessed by the control unit (401); (S560).

17. A method for operating an interactive multilingual advertisement system comprising;
first, the application program provided from the ads server (400) is executed at the user terminal (100) subscribed as a member to the ads server (400); (S600)
the control unit (401) of the ads server (400) checks if SNS messenger text information from the user terminal (100) is received; (S610), and stand-by for the SNS messenger text information,
at the said step; (S610), if SN messenger text information from the user terminal (100) is received via server communication unit (410), then the control unit (401) stores received SN messenger text information into the receive buffer (430); (S620)
then the control unit (401) reads out stored text information from the receive buffer (430), and provides the code identifier (460) with the reads out text information from the receive buffer (430), and identify character code and language. and the control unit (401) provides the words extractor (440) with the receive buffer (430) data with the text information, and extracts words referring ‘spaces’ or symbols; (S630)
next, the control unit (401) provides synonym dictionary (450) with the extracted words, to search out synonyms and thesaurus; (S640)
then the control unit (401) retrieves the ads meta data (470) for each language using the words extracted from the words extractor (440) and retrieved synonyms and thesaurus; (S650)
at the said step; (S650), if matched data is not searched out from the ads meta data (470), the control unit (401) re-executes the said step (S620),
at the said step; (S650), if matched meta data is searched out from the ads meta data (470), the control unit (401) reads out ads data file and URL information linked to the matched meta data and stores transmit buffer (420), and transmits transmit buffer (420) data to the user terminal (100) via server communication unit (410); (S670)
followed by the previous step, the control unit (401) checks whether the user terminal (100) sustains connection; (S680), and for connected status the control unit (401) jumps to the step (S620), and for disconnected status jumps to the step (S610), and stand-by for the receiving text information from the user terminal (100).

18. The step (S670) of claim 17 more comprising;
the control unit (401) count exposure frequency of the ads data files and URL for the concerned sponsor (500), and count the frequency of transmission of the ads data files and URL for the concerned user terminal (100), to record into subscriber database respectively.

19. A method for operating an interactive multilingual advertisement system comprising;
first, the application of the invention received from the ads server (400) is executed at the user terminal (100); (S700)
then the controller (101) activates the screen divide module (113) and the display (103) is divided into SNS display area and ads display area; (S710)
next, the user terminal (100) start to exchange text information with SN group (200), and the controller (101) saves each of exchanged text information into the messenger buffer (110); (S720).
the controller (101) provides messenger words extract unit (111) with the text information stored in the messenger buffer (110), and text information is separated into words referred by the ‘space’ between, and separated words are relocated in the messenger buffer (110) and scrambled; (S730)
followed by the step (S730), the controller (101) transmits the words from the messenger buffer (110) to the ads server (400) via mobile communication unit (102); (S740)
next, the controller (101) waits and checks whether the ads data files and URLs received from the ads server (400); (S750)
at the previous step (S750), if there is no ads data files and URLs received from the ads server (400), the controller (101) jumps to the step (S720) to repeat process in sequence,
at the previous step (S750), if there are ads data files and URLs received from the ads server (400), the controller (101) stores received ads data files and URLs into the ads data and URL storage (112); (S760)
next to the step (S760), the controller (101) reads out information from the ads data and URL storage (112) to be displayed on the display (103) as serviced advertisement; (S770)
and the controller (101) checks whether the user terminal (100) sustains connection to the SN group (200); (S780), and for connected status the controller (101) jumps to the step (S720),
and for disconnected status the controller (101) ends operation of the user terminal (100).

20. The step (S770) of claim 19 more comprising;
The ads information provided from the ads server (400) is displayed on the ads display area in hyper-text or hyper-link format, which enables transferred to the SN group (200) as a message using ‘drag-and-move’ touch screen function of the user terminal (100).
